(19) United States
(12) Patent Application Publication
(10) Pub. No.: US 2006/0287952 A1
(43) Pub. Date: Dec. 21, 2006

(54) Method of selling a loss management system

(76) Inventor: Alvin David Toms, London (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/238,585

(22) Filed: Sep. 29, 2005

(30) Foreign Application Priority Data
Jun. 16, 2005 (AU) 2005903143

(51) Int. Cl. G06Q 40/00

(52) U.S. Cl. 705/39

(57) ABSTRACT

Methods and apparatus for selling a loss management system include bundling a high risk usage or high risk payment behaviour detection stage with a high risk application detection stage, wherein there is no additional charge than that for providing the high risk application detection stage. Also described are methods and apparatus for comparison of an incumbent loss management system without a high risk application detection stage against a new loss management system having a high risk application detection stage and a high risk usage or high risk payment behaviour detection stage, which include measuring for a decrease in the number of high risk users that actually gain access to products and services compared to those of the incumbent loss management system among other measures for providing comparisons.

### RELATED APPLICATIONS

This application claims priority to, and incorporates by reference, the entire disclosure of Australian Provisional Application No. 2005903143, filed on Jun. 16, 2005.

### FIELD OF THE INVENTION

The present invention relates to loss management systems and a method of selling the same.

### BACKGROUND

Service providers suffer a loss in relation to a particular custom when they provide a service to the customer, but the customer does not pay for the service provided. For service providers that rely on large volumes of transactions or where an individual loss can be significant the service provider often employs a loss management system in order to reduce these losses.

The market for loss management systems is highly competitive. There are two main types of loss management system for minimising losses from non-payment for a service. An example of such a service is access to a telecommunications network. The types are: (i) an upfront system for analysing applications to use the service, where the upfront system tries to detect applicants that are likely to not pay for the service, such as people with a bad credit rating or fraudsters; and (ii) a behaviour analysis system that tries to detect fraudulent use of the service in order to terminate such use to minimise loss. Many competing loss management systems available in the market place neglect the first type of the loss management process and provide only the second.

The first prior art loss management system 5 is shown in FIG. 2. It has an assessor 6 which receives applications 2 and as a result of the assessment accepts or rejects 7 the applications. Those which are accepted are provided with the service 3 applied for.

The second prior art loss management system 1 is shown in FIG. 1. The service is provided 3 to all applicants 2 (granted using a manual or traditional application acceptance process). An assessor 4 receives information on the usage and/or payment behaviour for the service and as a result determines whether a customer is of a high risk of non-payment. A decision can then be made on whether to continue to supply the service.

Both of these types of loss management system are currently provided independently of each other and both compete against each other.

### SUMMARY OF THE PRESENT INVENTION

According to a first aspect of the present invention there is provided a method of selling a loss management system having at least two stages, the method comprising bundling a high risk usage or high risk payment behaviour detection stage with a high risk application detection stage, wherein there is no additional charge than that for providing the high risk application detection stage.

By bundling both types of loss management system stages in this manner the bundled product can be competitive price-wise with competing products, but can offer the benefits of both types of loss minimisation.

In a preferred embodiment the cost for the high risk application detection stage is based on the reduction in average loss per transaction processed by the high risk usage stage or reduction in average loss per application processed by the high risk application stage that is achieved through the operation of the loss management system or one or more of its component parts.

In another preferred embodiment the cost of the high risk application detection stage is based on the number of transactions processed by the high risk usage detection stage or the number of applications processed by the high risk application stage.

Typically there is an incumbent system without a high risk application detection stage and the high risk application detection stage is offered on a trial basis.

Alternatively there is an incumbent system with an application detection stage and the method further includes conducting a trial to establish the superior performance of the two stage loss management system being sold.

According to a second aspect of the present invention there is provided a method of selling a loss management system having at least two stages, the method comprising bundling a high risk usage or high risk payment behaviour detection stage with a high risk application detection stage, wherein the cost of the bundled system is determined as if only the high risk application detection stage where being sold.

According to a third aspect of the present invention there is provided a method of comparison of an incumbent loss management system without a high risk application detection stage against a new loss management system having a high risk application detection stage and a high risk usage or high risk payment behaviour detection stage, comprising measuring for a decrease in the number of high risk users that actually gain access to products and services compared to those of the incumbent loss management system.

This measure shows the effectiveness of the high risk application stage and demonstrates the redundancy of the incumbent system.

According to a fourth aspect of the present invention there is provided a method of comparison of an incumbent loss management system with a high risk application detection stage against a new loss management system having a high risk application detection stage and a high risk usage or high risk payment behaviour detection stage, comprising measuring how many actual loss making historical applications were accepted by the incumbent system can be identified by the new system.

This measure shows how many of the loss making applications that the incumbent system erroneously accepted that would have been rejected by the new system.

According to a fifth aspect of the present invention there is provided a method of comparison of an incumbent loss management system with a high risk application detection stage against a new loss management system having a high risk application detection stage and a high risk usage or high risk payment behaviour detection stage, comprising measuring how many historical applications were rejected by the incumbent system but accepted contrary to its recommendation as part of a data exploration policy that would have been accepted by the new system have turned out to be profitable.

This measure shows how many of the profitable applications that the incumbent system was rejecting would have been accepted by the new system.

According to a sixth aspect of the present invention there is provided a method of comparison of an incumbent loss management system with a high risk application detection stage against a new loss management system having a high risk application detection stage and a high risk usage or high risk payment behaviour detection stage, comprising measuring how many applications that were accepted by the incumbent system but are rejected by the new system end up resulting in a loss.

According to a seventh aspect of the present invention there is provided a method of comparison of an incumbent loss management system with a high risk application detection stage against a new loss management system having a high risk application detection stage and a high risk usage or high risk payment behaviour detection stage, comprising measuring how many applications that are rejected by the incumbent system but are accepted by the new system and turn out to be profitable.

According to an eighth aspect of the present invention there is provided a method of comparison of an incumbent loss management system with a high risk application detection stage against a new loss management system having a high risk application detection stage and a high risk usage or high risk payment behaviour detection stage, comprising measuring how many loss making applications that were accepted by the incumbent system but rejected by the new system to produce a first measure, measuring how many loss making applications that were rejected by the incumbent system that were erroneously accepted by the new system to produce a second measure and subtracting the first measure form the second measure.

According to a ninth aspect of the present invention there is provided a method of comparison of an incumbent loss management system with a high risk application detection stage against a new loss management system having a high risk application detection stage and a high risk usage or high risk payment behaviour detection stage, comprising measuring how many profitable applications that were rejected by the incumbent system but were accepted by the new system as a first measure, measuring how many profitable applications that were accepted by the incumbent system that were erroneously rejected by the new system and subtracting the first measure form the second measure.

According to a tenth aspect of the present invention there is provided a method of charging for a loss management system comprising having a high risk application detection (first) stage and a high risk usage or high risk payment behaviour detection (second) stage, the method comprising charging a fixed price for every application processed by the first stage.

According to an eleventh aspect of the present invention there is provided a method of charging for a loss management system comprising having a high risk application detection (first) stage and a high risk usage or high risk payment behaviour detection (second) stage, the method comprising charging a fixed price for every transaction processed by the second stage.

Preferably only one of the two methods immediately above are used.

Preferably the fixed price is reviewed and adjusted according to the performance of the system, as measured by the average loss per application processed by the high risk application detection part or average loss per transaction processed by the high risk usage detection part.

Preferably, average loss calculations are made on the basis of unpaid amounts declared in company accounts.

According to a twelfth aspect of the present invention there is provided a computer program for controlling a computing device to operate one or more of the methods defined above.

According to a thirteenth aspect of the present invention there is provided a computer readable storage medium comprising a computer program as defined above.

According to a fourteenth aspect of the present invention there is provided an apparatus for conducting one of the above defined methods, comprising means for conducting each of the steps of the above defined methods.

### SUMMARY OF THE ACCOMPANYING DRAWINGS

In order to provide a better understanding, preferred embodiments of the present invention will now be described, by way of example only, with reference to the accompanying drawings, in which:

FIG. 1 is a schematic representation of a prior art loss management system;

FIG. 2 is a schematic representation of another prior art loss management system;

FIG. 3 is a schematic representation of preferred embodiment of a loss management system used in the present invention;

FIG. 4 is a schematic flow chart of a first preferred method of assessing a loss management system according to the present invention;

FIG. 5 is a schematic flow chart of a second preferred method of assessing a loss management system according to the present invention; and

FIG. 6 is a schematic flow chart of a third preferred method of assessing a loss management system according to the present invention.

In this description the phrase “loss management system” is intended to mean any system that is designed to facilitate the detection and management of any or all sources of loss in a business, including fraud and bad debt.

Referring to FIG. 3 there is shown a loss management system 10 used in the present invention. The loss management system 10 comprises a high risk application assessor part 14 and a high risk usage or high risk payment behaviour assessor part 18.

The high risk application assessor part 14 receives applications 12 for a product or service that involve the provision of credit. The part 14 assesses the applications and detects applications that present a high risk of causing a loss to the supplier of the products or services if the applications are accepted.

Goods or services are provided to successful applicants on a credit basis at 16.

The a high risk usage or high risk payment behaviour assessor part 18 receives information related to the usage and/or payment behaviour from successful applicant's use of a product or service, or their payments for the product or service and analyses this information for indications that a loss is likely to result to the supplier of the product or service if supply 16 of the product or service is continued.

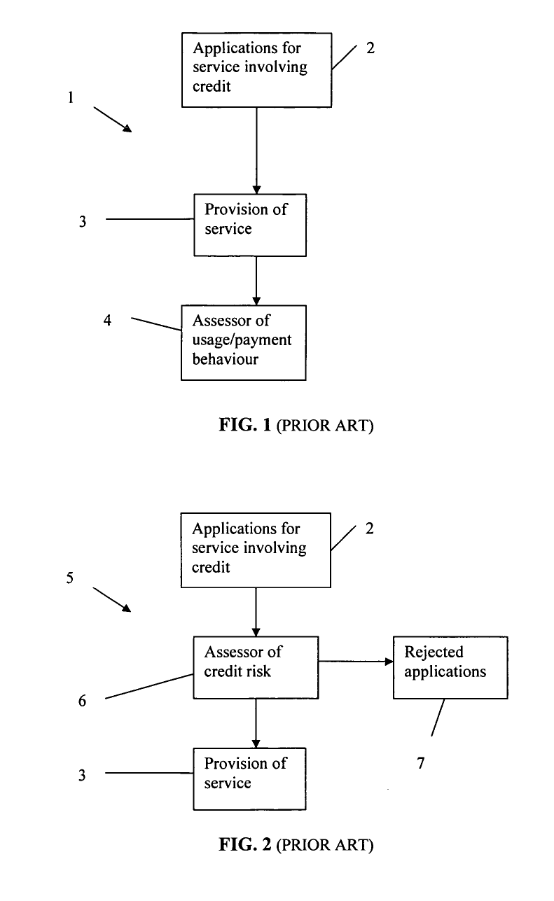

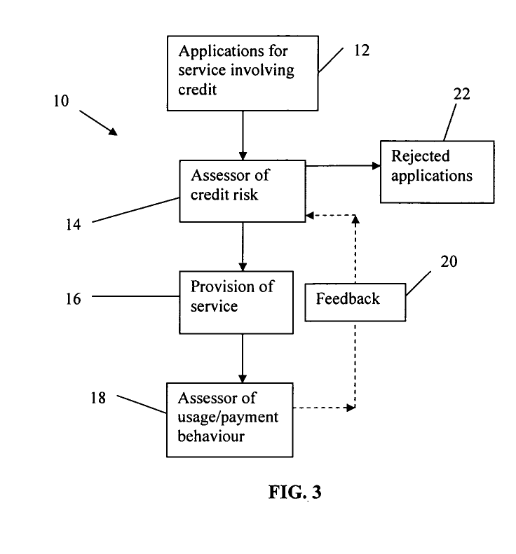

This loss management system 10 typically has a feedback mechanism 20 which enables the assessments of the part 18 as well as actual loss outcomes to improve the assessment of the part 14. This synergistic benefit that is not evident when the systems of FIGS. 1 and 2 are considered as products competing against each other, as is currently the case.

The present invention has been developed based on a number of unexpected realisations as to the fundamental nature of the market and the problem that the competing systems are designed to address. A first aspect of the invention exploits the fact that many competing products neglect the first stage (as is the case in FIG. 1) of the loss management process—that of detecting high risk applications—and provide only the second (part 4).

According to a first aspect of the present invention, the high risk usage or high risk payment behaviour detection part 18 of the system 10 is offered free with a purchase of the high risk application detection part 14. The expected consequences of this are that emphasis will be placed on the failure of the competing systems to provide an important functional component of a good loss management system. As a result the high risk usage or high risk payment behaviour detection part 4 of the competing system will effectively be devalued by competing with the equivalent part the bundled system, which is being offered for free.

A second aspect of the present invention is to assess the performance of competing systems. This can demonstrate the superior performance of the bundled system 10 against an incumbent system 1 or 5.

The high risk application detection part 14 can be offered on a (potentially free) trial basis if there is an incumbent system 1 that lacks a high risk application detection component. The intended consequences of this are that the high risk application detection part 14 should identify the majority of high risk users at the application stage, showing excellent performance in a trial, and causing a dramatic decrease in the effectiveness of the incumbent loss management system 4 when the number of high risk users that actually gain access to products and services inevitably drops. This simultaneously proves the effectiveness of the high risk application detection component 14 or the new system 10 and demonstrates at least in part the redundancy of the incumbent system 1.

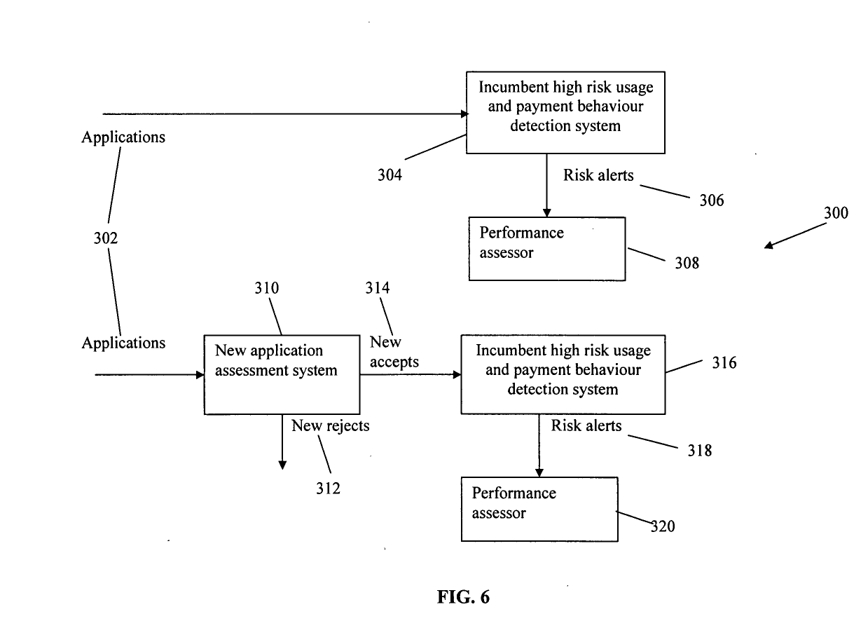

A method 300 of conducting a trial of an incumbent system 304 (1 in FIG. 1) against the system 10 is shown in FIG. 6. This trial will demonstrate the effect of introducing the new application assessment system 14 in front of a system 1 that has no application assessment stage. Prior to the introduction of the new application assessment system 310 (14 in FIG. 3), a performance assessor 308, which receives risk alerts from incumbent system 304, will show that the incumbent system generates relatively few false alerts from applications 302. The new system 310 rejects 312 some of the applications 302 and accepts 314 the other applications 302. Once the new system 310 is introduced the number of bad subscribers able to reach the usage stage 16 will be reduced and hence the number of bad subscribers detected by the incumbent usage and payment analysis system 316 will drop, causing its performance to deteriorate when the risk alerts 318 are assessed by performance assessor 320.

The performance of the bundled system 10 can also be compared against an incumbent system 5 that does contain a high risk application detection component but no usage/payment behaviour assessor. This is achieved by means of a trial that does at least one of the following:
(1) Assess the performance of the new system on historical applications that were accepted by the incumbent system. For these applications, it will be known which produced a loss for the provider and which were profitable. The performance assessment consists of taking a subset of the historical accepted applications and measuring how many of the loss making ones can be identified by the new system. This tells the operator how many of the loss making applications that the incumbent system erroneously accepted would have been rejected by the new system.
(2) Assess the performance of the new system on historical applications that were rejected by the incumbent system but accepted contrary to its recommendation as part of a data exploration policy. Sometimes an operator will accept a small number of applications contrary to the recommendations of their application assessment systems. This allows the operator to gain important statistical information about the applications that the systems are rejecting, which can be invaluable in benchmarking new systems against incumbent systems, and can but done at arbitrarily low risk by keeping the proportion of rejected applications that are accepted arbitrarily low. If the operator has such a set of data they will also know which of the applications made them a loss and which were profitable. The performance assessment in this type of trial consists of taking a subset of the applications that were recommended for rejection by the incumbent systems but were accepted, and measuring how many of that subset that would have been accepted by the new system have turned out to be profitable. This gives a measure of how many of the profitable applications that the incumbent system was rejecting would have been accepted by the new system.
(3) Assess the performance of the new system on applications that are either accepted or rejected by the incumbent system during a live trial. Sometimes a provider is unable or unwilling to allow for either of the trial schemes outlined above. This can be because they believe that performance assessments made on the basis of historical applications will not provide a good indication of the performance of a system in future because of the dynamic nature of their products and services, or because they never accept applications that their application assessment systems recommend that they should reject. In such cases, the only way to assess the performance of a new system against an incumbent is to run the two systems in a live trial. Live trials can be conducted in essentially two ways:
   (3A) Measure the number of applications that were accepted by the incumbent system but rejected by the new system that end up making the operator a loss, and
   (3B) Measure the number of applications that were rejected by the incumbent system that were accepted for the purposes of data exploration, and were accepted by the new system that end up making the operator a profit.

Each of these trials is equivalent to one of the first two except that they occur in a live environment rather than being conducted on historical data. It should be noted that trials conducted on historical data are preferable to live trials because operators will typically only declare an application as having been profitable if no loss has been incurred against it in the eighteen months since it was accepted. This means that live trials take a long time to complete, which is undesirable for both buyer and seller.

Although the trials described together provide indications of performance that are sufficient for commercial purposes they do not constitute rigorous assessments of performance. For example, a system could trivially reject all applications that were accepted by the incumbent system thereby rejecting all loss making applications that it accepted, and accept all applications that the incumbent system rejected, thereby accepting all profitable applications that it rejected. Such a system might score quite well according to the above measures but would probably not provide useful application assessments.

To provide an exact measure of performance it is necessary to subtract from the number of loss making applications that were accepted by the incumbent system but rejected by the new system the number of loss making applications that were rejected by the incumbent system that were erroneously accepted by the new system. Similarly, it is also necessary to subtract from the number of profitable applications that were rejected by the incumbent system but were accepted by the new system the number of profitable applications that were accepted by the incumbent system that were erroneously rejected by the new system.

This more complex way of measuring performance is not preferred since it introduces a dependency between the separate trials and cannot be calculated without information as to whether applications that were rejected by the incumbent system would have been profitable if they had been accepted, which is not usually available. Similarly, the complexity of the measure can conceal the real performance benefits of the new system, which is in the interests of neither the buyer nor the seller.

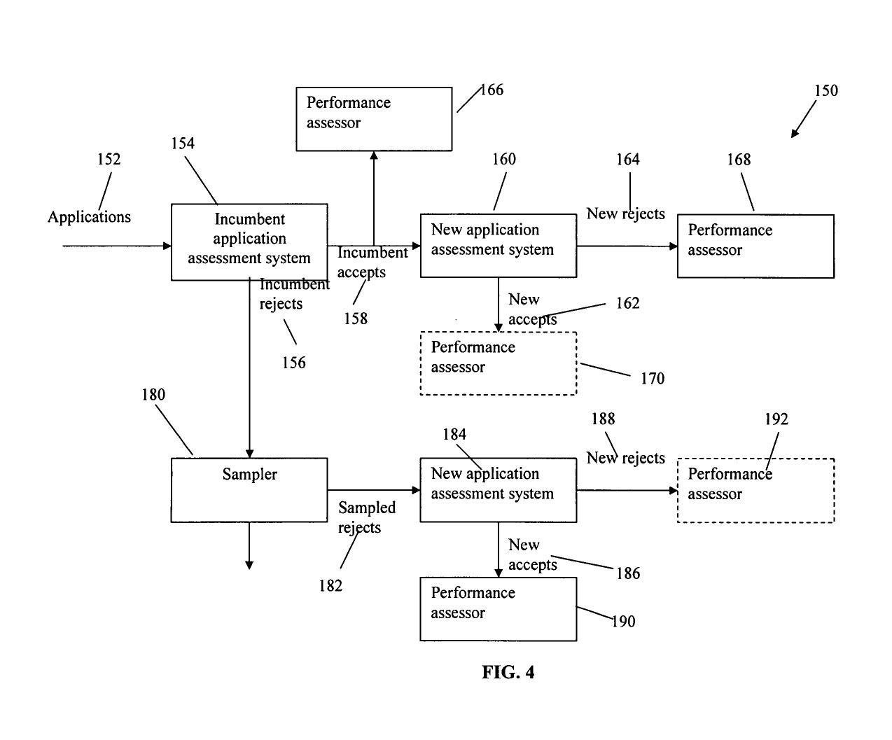

The first and second trial methods are shown as 150 and described in more detail in relation to FIG. 4. This method is conducted as an online or offline assessment of the performance of the new system 10 against an incumbent system 154 (5 in FIG. 2, which has an application assessment assessor 6). In an online assessment current real time data is used. In an offline assessment historic data with known outcomes is used.

The applications 152 are given to the incumbent application assessment system 154, which rejects 156 those applications deemed to be of too high a risk and accepts 158 those applications which are of an acceptable risk. Since the outcome is known (or ultimately will become known), a performance assessor 166 can assess the performance of the incumbent system by comparing the accepted applications that turn out be profitable to those that turn out to make a loss (hereafter called “bads”).

Those applications that are accepted 158 can be provided to the new system 160 (10 in FIG. 3). The part 14 will produce accepted applications 162 and rejected applications 164. A performance assessor 168 can assess the new system 10 by comparing those applications that were rejected 164 to those accepted 158, and particularly to those which where rejected 164 and ultimately turned out to be bads.

The number of bads in the new rejects provides an indication of the uplift that is provided by the new system in terms of the number of bad applications that were accepted by the incumbent system but rejected by the new one. The assessment can be done online as applications are made or, preferably on historical data, in which case, an application may be processed by the new application assessment system months or years after it is processed by the incumbent system, and usually only once the application has been identified as good or bad.

Assessment of the outcomes of applications that are accepted by both systems by performance assessor 170 is optional since it provides no information as to the relative performance of the two systems.

In the second (2) trial method a sampler 180 takes some proportion 182 of the applications rejected 156 by the incumbent system 154 and passes them through the new application system 184 (again 14 in FIG. 3), which produces new system accepted applications 186 and new system rejected applications 188. The outcomes of those applications that are accepted 186 by the new system 184 are used by the performance assessor 190 to assess the uplift that the new system 184 will give over the incumbent system 154. The applications that have been rejected by both the incumbent and new systems may or may not be used by performance assessor 192 since they are likely to represent a serious risk and their outcomes are not important in establishing the relative performance of the two systems.

The outcomes of the applications that were rejected by the incumbent system 154 but accepted by the new system 184 provides information on the number of “good” applications that were being missed by the incumbent system that could be found by the new system 184. The assessment can be done online as applications are made or on historical data, in which case, an application may be processed by the new application assessment system months or years after it is processed by the incumbent system, and usually only once the application has been identified as good or bad. Applications that were accepted by the incumbent system or sampled need not be processed at the same time; one set could be done online, the other offline from historical data.

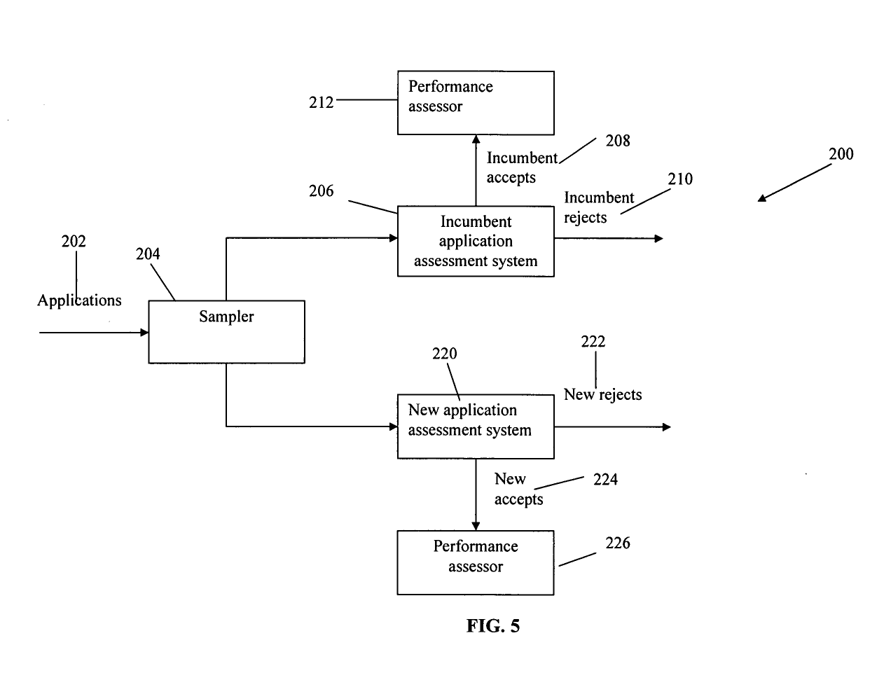

Another trial method 200 is described in more detail in relation to FIG. 5. In this arrangement, the incumbent and new application systems 206 and 220 are trialled online in parallel. The sampler 204 divides applications 202 between the incumbent system 206 and new application assessment system 220, preferably on a random basis, and in predefined proportions. It is necessary only to assess the outcomes of the applications that are accepted by either system. Thus accepted applications 208 of the incumbent system 206 are provided to performance assessor 212 and accepted applications 224 of the new system 220 are provided to performance assessor 226. Incumbent system rejects 210 and new system rejects 222 are discarded. The performance assessors 212 and 226 compare the accepted applications to the ultimate outcomes—good or bad. The results from the performance assessors 212 and 226 can be compared.

A third aspect of the present invention relates to a way of charging for the new system 10 that allows the vendor to benefit from growth in the volume of applications assessed using their system, and allows the client to share the risks associated with under performance while providing the vendor with an incentive for continual innovation and performance improvement. These goals are achieved by introducing a pricing system that operates in such a way that:
(1) The client pays the vendor a fixed price for every application processed by the high risk application detection part, or every transaction processed by the high risk usage detection part. This means that the revenue to the vendor increases as the client gets greater utility from the system.
(2) The fixed price is to be regularly reviewed and adjusted according to the performance of the system, as measured by the average loss per application processed by the high risk application detection part or average loss per transaction processed by the high risk usage detection part. This means that improvements in the performance of the system that benefit the client also deliver increased revenue to the vendor, thereby encouraging a relationship of symbiotic mutual interest between client and vendor. Preferably, average loss calculations are made on the basis of unpaid amounts declared in company accounts.

The term “transaction” is intended to apply to any instance of a purchase of goods or use of services on credit. The term therefore applied not only to credit card purchases, which are traditionally referred to as transactions, but also to individual uses of a telecommunications service. Since each use instance is provided on credit, each also corresponds implicitly to a credit transaction.

The above described methods can be implemented as a computer program, which can be stored on a computer readable medium (such as a CD, DVD, hard disk drive or other non-volatile storage means), arrange to control a computer or number of computers to perform the method/s.

Modifications and variations may be made to the present invention without departing form the inventive concept. Such modifications and variations are intended to fall within the scope of the present invention, the nature of which is to be determined from the foregoing description and appended claims.

1. A method of selling a loss management system having at least two stages, the method comprising:
bundling a high risk usage or high risk payment behaviour detection stage with a high risk application detection stage, wherein there is no additional charge than that for providing the high risk application detection stage.

2. A method as claimed in claim 1, wherein charges for the high risk application detection stage are based on the reduction in average loss per transaction processed by the high risk usage stage or reduction in average loss per application processed by the high risk application stage that is achieved through the operation of the loss management system or one or more of its component parts.

3. A method as claimed in claim 1, wherein charges for the high risk application detection stage are based on the number of transactions processed by the high risk usage detection stage or the number of applications processed by the high risk application stage.

4. A method as claimed in any one of claims 1, 2, or 3, wherein there is an incumbent system without a high risk application detection stage and the high risk application detection stage is offered on a trial basis.

5. A method as claimed in any one of claims 1, 2, or 3, wherein there is an incumbent system with an application detection stage and the strategy further includes conducting a trial to establish the superior performance of the two stage loss management system being sold.

6. A method of comparison of an incumbent loss management system without a high risk application detection stage against a new loss management system having a high risk application detection stage and a high risk usage or high risk payment behaviour detection stage, comprising:
measuring for a decrease in the number of high risk users that actually gain access to products and services compared to those of the incumbent loss management system.

7. A method of comparison of an incumbent loss management system with a high risk application detection stage against a new loss management system having a high risk application detection stage and a high risk usage or high risk payment behaviour detection stage, comprising:
measuring how many actual loss making historical applications were accepted by the incumbent system can be identified by the new system.

8. A method of comparison of an incumbent loss management system with a high risk application detection stage against a new loss management system having a high risk application detection stage and a high risk usage or high risk payment behaviour detection stage, comprising:
measuring how many historical applications were rejected by the incumbent system but accepted contrary to its recommendation as part of a data exploration policy that would have been accepted by the new system have turned out to be profitable.

9. A method of comparison of an incumbent loss management system with a high risk application detection stage against a new loss management system having a high risk application detection stage and a high risk usage or high risk payment behaviour detection stage, comprising:
measuring how many applications that were accepted by the incumbent system but are rejected by the new system end up resulting in a loss.

10. A method of comparison of an incumbent loss management system with a high risk application detection stage against a new loss management system having a high risk application detection stage and a high risk usage or high risk payment behaviour detection stage, comprising:
measuring how many applications that are rejected by the incumbent system but are accepted by the new system and turn out to be profitable.

11. A method of comparison of an incumbent loss management system with a high risk application detection stage against a new loss management system having a high risk application detection stage and a high risk usage or high risk payment behaviour detection stage, comprising:
measuring how many loss making applications that were accepted by the incumbent system but rejected by the new system to produce a first measure;
measuring how many loss making applications that were rejected by the incumbent system that were erroneously accepted by the new system to produce a second measure;
subtracting the first measure form the second measure.

12. A method of comparison of an incumbent loss management system with a high risk application detection stage against a new loss management system having a high risk application detection stage and a high risk usage or high risk payment behaviour detection stage, comprising:
measuring how many profitable applications that were rejected by the incumbent system but were accepted by the new system as a first measure;
measuring how many profitable applications that were accepted by the incumbent system that were erroneously rejected by the new system;
subtracting the first measure form the second measure.

13. A method of charging for a loss management system comprising a high risk application detection (first) stage and a high risk usage or high risk payment behaviour detection (second) stage, the method comprising:
charging a fixed price for every application processed by the first stage.

14. A method of charging for a loss management system comprising a high risk application detection (first) stage and a high risk usage or high risk payment behaviour detection (second) stage, the method comprising:
charging a fixed price for every transaction processed by the second stage.

15. A method according to either claim 13 or 14, wherein no other charging is employed.

16. A method according to either claim 13 or 14, wherein the fixed price is reviewed and adjusted according to the performance of the system, as measured by the average loss per application processed by the high risk application detection part or average loss per transaction processed by the high risk usage detection part.

17. A method according to claim 16, wherein average loss calculations are made on the basis of unpaid amounts declared in company accounts.

18. A computer program for controlling a computing device to operate a method of selling a loss management system having at least two stages, the method comprising:
bundling a high risk usage or high risk payment behaviour detection stage with a high risk application detection stage, wherein there is no additional charge than that for providing the high risk application detection stage.

19. A computer program for controlling a computing device to operate a method of comparison of an incumbent loss management system without a high risk application detection stage against a new loss management system having a high risk application detection stage and a high risk usage or high risk payment behaviour detection stage, comprising:
measuring for a decrease in the number of high risk users that actually gain access to products and services compared to those of the incumbent loss management system.

20. A computer program for controlling a computing device to operate a method of comparison of an incumbent loss management system with a high risk application detection stage against a new loss management system having a high risk application detection stage and a high risk usage or high risk payment behaviour detection stage, comprising:
measuring how many actual loss making historical applications were accepted by the incumbent system can be identified by the new system.

21. A computer program for controlling a computing device to operate a method of comparison of an incumbent loss management system with a high risk application detection stage against a new loss management system having a high risk application detection stage and a high risk usage or high risk payment behaviour detection stage, comprising:
measuring how many historical applications were rejected by the incumbent system but accepted contrary to its recommendation as part of a data exploration policy that would have been accepted by the new system have turned out to be profitable.

22. A computer program for controlling a computing device to operate a method of comparison of an incumbent loss management system with a high risk application detection stage against a new loss management system having a high risk application detection stage and a high risk usage or high risk payment behaviour detection stage, comprising:
measuring how many applications that were accepted by the incumbent system but are rejected by the new system end up resulting in a loss.

23. A computer program for controlling a computing device to operate a method of comparison of an incumbent loss management system with a high risk application detection stage against a new loss management system having a high risk application detection stage and a high risk usage or high risk payment behaviour detection stage, comprising:
measuring how many applications that are rejected by the incumbent system but are accepted by the new system and turn out to be profitable.

24. A computer program for controlling a computing device to operate a method of comparison of an incumbent loss management system with a high risk application detection stage against a new loss management system having a high risk application detection stage and a high risk usage or high risk payment behaviour detection stage, comprising:
measuring how many loss making applications that were accepted by the incumbent system but rejected by the new system to produce a first measure;
measuring how many loss making applications that were rejected by the incumbent system that were erroneously accepted by the new system to produce a second measure;
subtracting the first measure form the second measure.

25. A computer program for controlling a computing device to operate a method of comparison of an incumbent loss management system with a high risk application detection stage against a new loss management system having a high risk application detection stage and a high risk usage or high risk payment behaviour detection stage, comprising:
measuring how many profitable applications that were rejected by the incumbent system but were accepted by the new system as a first measure;
measuring how many profitable applications that were accepted by the incumbent system that were erroneously rejected by the new system;
subtracting the first measure form the second measure.

26. A computer program for controlling a computing device to operate a method of charging for a loss management system comprising a high risk application detection (first) stage and a high risk usage or high risk payment behaviour detection (second) stage, the method comprising:
charging a fixed price for every application processed by the first stage.

27. A computer program for controlling a computing device to operate a method of charging for a loss management system comprising a high risk application detection (first) stage and a high risk usage or high risk payment behaviour detection (second) stage, the method comprising:
charging a fixed price for every transaction processed by the second stage.

28. A computer readable storage medium comprising a computer program as defined in claim 18.

29. A computer readable storage medium comprising a computer program as defined in claim 19.

30. A computer readable storage medium comprising a computer program as defined in claim 20.

31. A computer readable storage medium comprising a computer program as defined in claim 21.

32. A computer readable storage medium comprising a computer program as defined in claim 22.

33. A computer readable storage medium comprising a computer program as defined in claim 23.

34. A computer readable storage medium comprising a computer program as defined in claim 24.

35. A computer readable storage medium comprising a computer program as defined in claim 25.

36. A computer readable storage medium comprising a computer program as defined in claim 26.

37. A computer readable storage medium comprising a computer program as defined in claim 27.

38. An apparatus for conducting a method of selling a loss management system having at least two stages, the apparatus comprising:
means for bundling a high risk usage or high risk payment behaviour detection stage with a high risk application detection stage, wherein there is no additional charge than that for providing the high risk application detection stage.

39. An apparatus for conducting a method of comparison of an incumbent loss management system without a high risk application detection stage against a new loss management system having a high risk application detection stage and a high risk usage or high risk payment behaviour detection stage, comprising:
means for measuring for a decrease in the number of high risk users that actually gain access to products and services compared to those of the incumbent loss management system.

40. An apparatus for conducting a method of comparison of an incumbent loss management system with a high risk application detection stage against a new loss management system having a high risk application detection stage and a high risk usage or high risk payment behaviour detection stage, comprising:
means for measuring how many actual loss making historical applications were accepted by the incumbent system can be identified by the new system.

41. An apparatus for conducting a method of comparison of an incumbent loss management system with a high risk application detection stage against a new loss management system having a high risk application detection stage and a high risk usage or high risk payment behaviour detection stage, comprising:
means for measuring how many historical applications were rejected by the incumbent system but accepted contrary to its recommendation as part of a data exploration policy that would have been accepted by the new system have turned out to be profitable.

42. An apparatus for conducting a method of comparison of an incumbent loss management system with a high risk application detection stage against a new loss management system having a high risk application detection stage and a high risk usage or high risk payment behaviour detection stage, comprising:
means for measuring how many applications that were accepted by the incumbent system but are rejected by the new system end up resulting in a loss.

43. An apparatus for conducting a method of comparison of an incumbent loss management system with a high risk application detection stage against a new loss management system having a high risk application detection stage and a high risk usage or high risk payment behaviour detection stage, comprising:
means for measuring how many applications that are rejected by the incumbent system but are accepted by the new system and turn out to be profitable.

44. An apparatus for conducting a method of comparison of an incumbent loss management system with a high risk application detection stage against a new loss management system having a high risk application detection stage and a high risk usage or high risk payment behaviour detection stage, comprising:
means for measuring how many loss making applications that were accepted by the incumbent system but rejected by the new system to produce a first measure;
means for measuring how many loss making applications that were rejected by the incumbent system that were erroneously accepted by the new system to produce a second measure;
means for subtracting the first measure from the second measure.

45. An apparatus for conducting a method of comparison of an incumbent loss management system with a high risk application detection stage against a new loss management system having a high risk application detection stage and a high risk usage or high risk payment behaviour detection stage, comprising:
means for measuring how many profitable applications that were rejected by the incumbent system but were accepted by the new system as a first measure;
means for measuring how many profitable applications that were accepted by the incumbent system that were erroneously rejected by the new system;
means for subtracting the first measure from the second measure.

46. An apparatus for conducting a method of charging for a loss management system comprising a high risk application detection (first) stage and a high risk usage or high risk payment behaviour detection (second) stage, the apparatus comprising:
means for charging a fixed price for every application processed by the first stage.

47. An apparatus for conducting a method of charging for a loss management system comprising a high risk application detection (first) stage and a high risk usage or high risk payment behaviour detection (second) stage, the apparatus comprising:
means for charging a fixed price for every transaction processed by the second stage.
